(19) United States
(12) Patent Application Publication
(10) Pub. No.: US 2025/0119388 A1
(43) Pub. Date: Apr. 10, 2025

(54) APPARATUS AND METHOD FOR PROVIDING SETTING INFORMATION ON TIME SENSITIVE NETWORKING TALKER AND LISTENER FOR TIME SENSITIVE NETWORKING TRANSPORT IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Changki KIM, Daejeon (KR); Seung Han CHOI, Daejeon (KR)

(21) Appl. No.: 18/907,199

(22) Filed: Oct. 4, 2024

(30) Foreign Application Priority Data
Oct. 6, 2023 (KR) 10-2023-0133671
Nov. 30, 2023 (KR) 10-2023-0171898
Oct. 2, 2024 (KR) 10-2024-0133559

(51) Int. Cl. H04L 47/28; H04L 47/2416

(52) U.S. Cl. CPC H04L 47/28; H04L 47/2416

(57) ABSTRACT

The present disclosure relates generally to a wireless communication system. More particularly, the present disclosure relates to an apparatus and a method for providing setting information on a time-sensitive networking talker and listener for time-sensitive networking (TSN) transport in a wireless communication system. According to various embodiments of the present disclosure, provided is a method of giving notification of whether a radio access network (RAN) supports a time-sensitive networking (TSN) talker/listener in a wireless communication system, the method including notifying, by the RAN, either an access and mobility management function (AMF) or a session management function (SMF) by using an NGAP message.

### TECHNOLOGY FIELD

The present disclosure relates generally to a wireless communication system. More particularly, the present disclosure relates to an apparatus and a method for providing setting information on a time-sensitive networking talker and listener for time-sensitive networking (TSN) transport in a wireless communication system.

### BACKGROUND OF THE DISCLOSURE

In order to efficiently support time-sensitive communication, when a 5G mobile communication network supports interworking with the Institute of Electrical and Electronics Engineers (IEEE) time-sensitive networking (TSN) deployed in a transmission network, a centralized user configuration (CUC) co-located with a session management function (SMF) or an independently existing CUC may interwork with a transport network centralized network configuration (TN CNC) of the transmission network. The SMF/CUC may refer to both a CUC co-located with an SMF and an independent CUC. The SMF/CUC may determine paths and schedules in the transmission network for QoS flow-based stream requirements. The SMF/CUC collects TSN communication requirements for an access network TSN talker/lister (AN-TL) co-located with a RAN and a core network TSN talker/listener (CN-TL) co-located with a UPF and provides the requirements to the TN CNC to enable time-sensitive communication.

When the SMF sets a new QoS flow, core network packet delay budget (CN PDB) and times synchronization communication assistance information (TSCAI) for the QoS flow are transmitted to a radio access network (RAN). When the TSCAI received from the SMF includes uplink (UL) burst arrival time (BAT), the RAN may calculate an access network packet delay budget (AN PDB) and provide the same to the SMF.

When the SMF/CUC receives information that the RAN supports the AN-TL, and recognizes that the UPF supports the CN-TL, the SMF/CUC may insert get-request, get-response, set-request, and set-response into a TL-container for each of the PAN and the UPF to collect setting and capability information of the AN-TL and the CN-TL and provide gate control information for TSN communication. Accordingly, the AN-TL and CN-TL provide a hold and buffer function, so that time-sensitive communication is achieved.

### Content of the Invention

### The Object of the Invention

On the basis of the above description, the present disclosure relates to a wireless communication system. More specifically, the present disclosure provides an apparatus and a method for providing setting information on a time-sensitive networking talker and listener for TSN transport in a wireless communication system.

In addition, the present disclosure provides an apparatus and a method for providing a session management function (SMF) with information on whether a radio access network (RAN) supports a TSN talker/listener (AN-TL) in a wireless communication system.

In addition, the present disclosure provides an apparatus and a method for registering information on whether an SMF is co-located with a centralized user configuration (CUC) in a wireless communication system at a network repository function (NRF) to enable another network function (NF), such as an access and mobility management function (AMF), to search for an SMF/CUC.

### Technical Object of the Invention

According to various embodiments of the present disclosure, there is provided a method of giving notification of whether a radio access network (PAN) supports a time-sensitive networking (TSN) talker/listener in a wireless communication system, the method including notifying, by the RAN, either an access and mobility management function (AMF) or a session management function (SMF) by using an NGAP message.

According to various embodiments of the present disclosure, there is provided a method of giving notification of whether a radio access network (PAN) supports a time-sensitive networking (TSN) talker/listener in a wireless communication system, the method including notifying, by an access and mobility management function (AMF), a session management function (SMF) by using a service based interface (SBI).

According to various embodiments of the present disclosure, there is provided an operation method of a session management function (SMF) in a wireless communication system, the operation method including registering the SMF at a network repository function (NRF) by using an NFRegister message including information indicating that the SMF is co-located with a centralized user configuration (CUC).

### Effect of the Invention

The apparatus and the method according to various embodiments of the present disclosure searches for an SMF supporting a session management function (SMF)/centralized user configuration (CUC) for a session request from a radio access network (RAN) supporting a TSN talker/listener (AN-TL) in a wireless communication network supporting time-sensitive networking (TSN) transport, thereby enabling the SMF to set a QoS flow using the AN-TL.

Effects that may be obtained from the present disclosure will not be limited to only the above described effects. In addition, other effects which are not described herein will become apparent to those skilled in the art from the following description.

### BRIEF DESCRIPTION OF THE DRAWINGS

FIG. 1 shows an example of the architecture of a 5G network, according to various embodiments of the present disclosure.

FIG. 2 shows an example of the architecture of a 5G network having TSN transport, according to an embodiment of the present disclosure.

FIG. 3 shows an example of a 5G network having a TSN transport network and a conventional transport network together, according to an embodiment of the present disclosure.

FIG. 4 shows a process in which an SMF registers itself to an NRF, according to an embodiment of the present disclosure.

FIG. 5 shows a process in which an AMF searches for an SMF through an NRF, according to an embodiment of the present disclosure.

FIG. 6 shows a process for an AMF to make a request to an SMF for a session establishment service, according to an embodiment of the present disclosure.

FIG. 7 shows a process for a RAN to make a request to an AMF for NG-Setup, according to an embodiment of the present disclosure.

FIG. 8 shows an example of a process for a RAN to make a request for AMF session establishment, according to an embodiment of the present disclosure.

FIG. 9 shows another example of a process for a RAN to make a request for AMF session establishment, according to an embodiment of the present disclosure.

FIG. 10 shows an example in which an AMF makes a request to an SMF for a session modification service, according to an embodiment of the present disclosure.

FIG. 11 shows a configuration of an apparatus according to various embodiments of the present disclosure.

### DETAILED DESCRIPTION OF THE EMBODIMENTS

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for providing setting information on a time-sensitive networking talker and listener for time-sensitive networking (TSN) transport in a wireless communication system. Specifically, the present disclosure describes a method of receiving, by a session management function (SMF), information on whether a radio access network (RAN) requesting session establishment or modification serves as a time-sensitive networking (TSN) talker/lister in a wireless communication system, and a technology for registering information on whether the SMF is co-located with a centralized user configuration (CUC), at a network repository function (NRF).

That is, it takes a considerable amount of time to enable the entire wireless communication network to support TSN transport. Thus, if the entire wireless communication network does not support TSN transport and only some RANs support a TSN talker/lister (AN-TL) and only some UPFs support a TSN talker/lister (CN-TL), the present disclosure enables the SMF/CUC to recognize whether a RAN is a RAN supporting an AN-TL to facilitate scheduling for time-sensitive communication using TSN transport with the RAN.

In addition, according to the present disclosure, if an access and mobility management function (AMF), which relays signaling between a RAN and an SMF, determines which SMF a session establishment request or a session modification request from a RAN is relayed to, when the RAN supports an AN-TL, an SMF co-located with a CUC is found and the request is relayed to the SMF/CUF.

In the related art, there is no way to forward information on whether any of multiple RANs support an AN-TL, to an SMF/CUC, and how to find a SMF providing SMF/CUC among multiple SMFs has not been researched.

Accordingly, the present disclosure enables information on whether a RAN supports an AN-TL to be forwarded to an SMF. In addition, the present disclosure enables the AMF to search for the SMF/CUC by registering information on whether the SMF is co-located with the CUC, to the NRF.

To this end, according to the present disclosure, for a RAN supporting an AN-TL, information on whether the RAN supports an AN-TL may be provided to an SMF from an AMF, and the SMF may receive information on whether the RAN supports an AN-TL through a session establishment request or session modification request message or other messages.

In addition, according to the present disclosure, an SMF supporting an SMF/CUC may register information that the SMF itself provides the CUC together, to an NRF, so that another NF, such as an AMF, may search for an SMF supporting an SMF/CUC.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

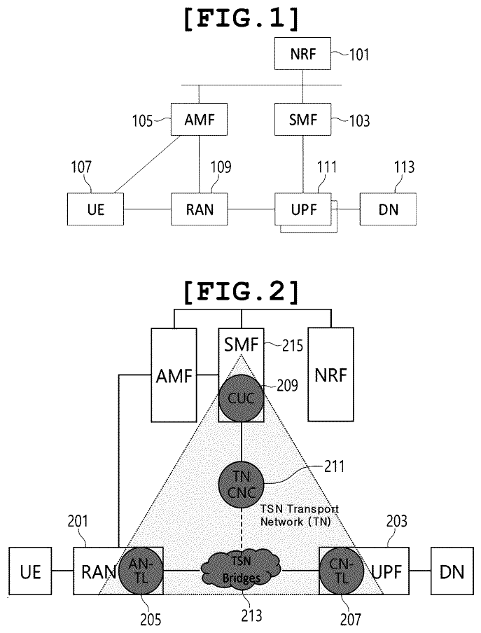

FIG. 1 shows an example of the architecture of a 5G network, according to various embodiments of the present disclosure.

Referring to FIG. 1, a network repository function (NRF) 101, a session management function (SMF) 103, and an access and mobility management function (AMF) 105 are functional elements for controlling a 5G system. The NRF is a central registration function within a core network (CN), and obtains and manages registration of network functions (NFs) within the core network and provides registration information of the NFs to other NFs. The AMF manages the access and mobility of a UE, and the SMF manages a session. A message related to a session between the SMF and a UE is forwarded via the AMF, and a non access stratum (NAS) message between the AMF and a UE 107 is forwarded via a radio access network (RAN) 109.

A UPF 111 is a function that handles user data traffic, and forwards user traffic data between the radio access network (RAN) and a data network (DN) 113. The RAN forwards user traffic data between with the UE.

FIG. 2 shows an example of the architecture of a 5G network having TSN transport, according to an embodiment of the present disclosure.

Referring to FIG. 2, FIG. 2 shows the architecture that supports time-sensitive networking (TSN) transport between a RAN 201 and a UPF 203, unlike FIG. 1. The RAN 201 and the UPF 203 are connected by a TSN bridge, and each of the RAN 201 and the UPF 203 may serve as a TSN talker/listener. Herein, the RAN 201 serving as a TSN talker/listener is defined as an AN-TL 205, and the UPF 203 serving as a TSN talker/listener is defined as a CN-TL 207. The TSN communication requirements thereof may be provided to a centralized user configuration (CUC) 209. Regarding the network settings for the TSN communication requirements collected by the CUC 209, the time-sensitive communication schedule of TSN bridges 213 may be determined by a transport network centralized network configuration (TN CNC) 211.

The CUC 209 is co-located in the SMF 215 to collect the TSN communication requirements of the AN-TL 205 and the CN-TL 207 and provide the same to the TN CNC 211, thus enabling time-sensitive communication. When the SMF 215 sets a new QoS flow, core network packet delay budget (CN PDB) and TSC assistance information (TSCAI) for the QoS flow may be transmitted to the RAN.

According to an embodiment, a new QoS flow may be set through a session request process or a session modification process.

According to an embodiment, the CN PDB may be the maximum packet delay time from the N6 endpoint to the RAN.

According to an embodiment, the TSC assistance information (TSCAI) may describe the traffic characteristics of the TSC flow as time-sensitive communication support information.

When the TSCAI received from the SMF 215 includes UL BAT, the PAN 201 may calculate an access network packet delay budget (AN PDB) and provide the same to the SMF.

According to an embodiment, the burst arrival time (BAT) is the start time of the first packet of a data burst, and the UL BAT may be the BAT at the egress of the UE.

According to an embodiment, the AN PDB may be the maximum packet delay time from the UE to the RAN.

The SMF 215/CUC 209 may provide the TN CNC 211 with the QoS flow-based PDB and the stream requirements for TSCAI, and the TN CNC 211 may set the schedule of the TSN bridges of the transport network.

In addition, after receiving information that the RAN 201 supports the AN-TL 205 and the UPF 203 supports the CN-TL 207, the SMF 215/CUC 209 may insert get-request, get-response, set-request, and set-response into a TL-container for each of the RAN 201 and the UPF 203 to collect capability information of the AN-TL 205 and the CN-TL 207 and provide gate control information for TSN communication.

According to an embodiment, gate control may define a processing schedule for each traffic class queue for a network interface.

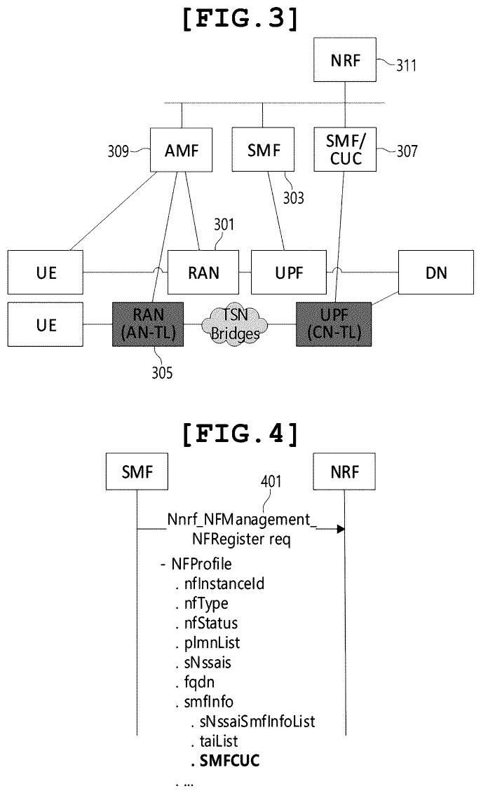

FIG. 3 shows an example of a 5G network having a TSN transport network and a conventional transport network together, according to an embodiment of the present disclosure.

Referring to FIG. 3, a request for a session through a conventional RAN 301 may be controlled through a conventional SMF 303. However, a request for a session from a RAN 301 supporting an AN-TL 305 needs to be controlled through an SMF/CUC 307. To this end, for a request from the RAN 301/AN-TL 305, an AMF 309 needs to request control by the SMF/CUC 307 rather than the SMF 303, and the AMF 309 may find the SMF/CUC 307 through a search of an NRF 311. The SMF 303 and the SMF/CUC 307 may be separately registered in advance to the NRF 311.

In the present disclosure, the SMF/CUC may refer to both a CUC co-located with an SMF and an independent CUC.

FIG. 4 shows a process in which an SMF registers itself to an NRF, according to an embodiment of the present disclosure. Specifically, FIG. 4 shows NFRegister of the Nnrf_NFManagement service as an example of a service used when an SMF registers itself to an NRF, and a part of the information element, NFProfile.

Referring to FIG. 4, when a 5G NF including the SMF registers itself to the NRF, NFRegister or NFUpdate of the Nnrf_NFManagement service may be used in step 401. According to an embodiment, in step 401, the 5G NF may include its information in NFProfile may provide the same to the NRF.

According to an embodiment, nfInstanceId, nfType, and nfStatus may be an instance identifier, type, and status of the NF registered to the NRF, respectively.

According to an embodiment, the PLMN and the slice supported by the NF may be represented as plmnList and sNssais, respectively. In addition, the domain name of the NR may be represented as fully qualified domain name (fqdn). In particular, when the NF registered to the NRF is an SMF, smfInfo is added. Herein, the slice and the TAI supported by the SMF may be represented as sNssaiSmfInfoList and taiList, respectively.

For example, the SMF may further include information on whether the SMF is co-located with the CUC, in the SMFCUC and transmit the same. The SMFCUC may be expressed in various forms indicating that the SMF and the CUC are co-located.

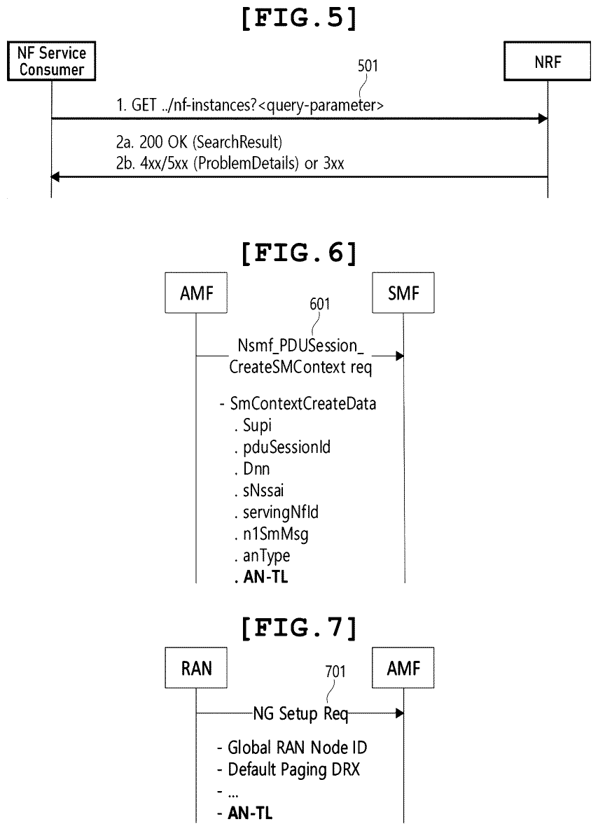

FIG. 5 shows a process in which an AMF searches for an SMF through an NRF, according to an embodiment of the present disclosure.

Referring to FIG. 5, when a 5G NF including the AMF searches for another NF through the NRF, NFDiscover of the Nnrf_NFDiscovery service may be used in step 501. Herein, step 501 may include a characteristic of an NF to be found with query-parameter. According to an embodiment, query-parameter represents the value of a required parameter with parameter=value. When there are multiple parameters, the parameters may be represented together with “&”.

For example, query-parameter may be represented as nfType=SMF&SMFCUC=1, and using nfType=SMF&SMFCUC=1, the SMF co-located with the CUC may be found. Herein, SMFCUC=1 indicates that the SMF and the CUC are co-located, and may be expressed in various forms.

FIG. 6 shows a process for an AMF to make a request to an SMF for a service, according to an embodiment of the present disclosure. Specifically, FIG. 6 shows an example in which the AMF makes a request to the SMF for Nsmf_PDUSession_CreateSMContextservice, which is a service based interface (SBI) service.

Referring to FIG. 6, when the AMF makes a request to the SMF for session establishment, the Nsmf_PDUSession_CreateSMContext service may be used in step 601. According to an embodiment, the Nsmf_PDUSession_CreateSMContext service in step 601 may include SmContextCreateData. A subscription permanent identifier (Supi) may be a user identifier of a UE requesting session establishment, and pduSessionId may be a session identifier. Dnn and sNssai may be a data network name and slice identification information to set for the session. servingNfId may be the identifier of the AMF, N1SmMsg may be an NAS message for a session establishment request, and anType may be the type of the access network. According to an embodiment, information on whether the RAN, which is the access network, provides a TSN talker/listener function may also be included. For example, AN-TL information may be included. Herein, the AN-TL may be represented in various forms indicating whether the RAN provides the TSN talker/listener function.

FIG. 7 shows a process for a RAN to make a request to an AMF for NG-Setup, according to an embodiment of the present disclosure.

Referring to FIG. 7, when the RAN makes a request to the AMF for connection for signaling, the RAN may inform the AMF that the RAN supports the AN-TL, by including AN-TL information in step 701. Afterward, as shown in FIG. 6, for a session request from the RAN, the AMF may inform the SMF that the RAN supports the AN-TL.

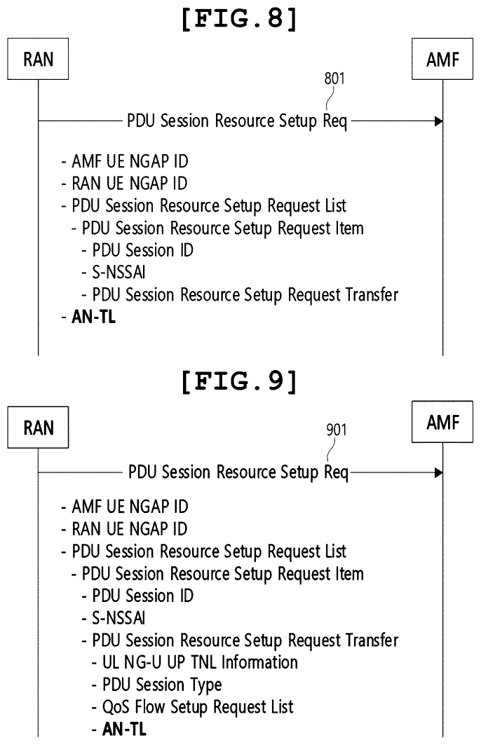

FIG. 8 shows an example of a process for a RAN to make a request for AMF session establishment, according to an embodiment of the present disclosure.

Referring to FIG. 8, when the RAN requests the AMF to set a session resource, the RAN may inform the AMF that the RAN supports the AL-TL, by including AN-TL information in step 801. As shown in FIG. 6, for a session request from the RAN, the AMF may inform the SMF that the RAN supports the AN-TL.

According to an embodiment, FIG. 7 shows a method in which the AMF stores information that the RAN supports the AN-TL, and for a session request from the RAN, the AMF may include AN-TL information in the SMF.

According to an embodiment, FIG. 8 shows a method in which a session request message includes information that the RAN supports the AN-TL, so the AMF may include AN-TL information in the SMF.

FIG. 9 shows another example of a process for a RAN to make a request for AMF session establishment, according to an embodiment of the present disclosure.

Referring to FIG. 9, when the RAN requests the AMF to set a session resource, the RAN includes AN-TL information in PDU Session Resource Setup Request Transfer to inform the SMF that the RAN supports the AN-TL in step 901. Regarding the SMF, for a session request from the RAN, the SMF may be informed that the RAN supports the AN-TL.

FIG. 8 shows the method in which the RAN provides AN-TL information to the AMF and the AMF informs the SMF of the AN-TL information, while FIG. 9 shows the method in which the RAN directly informs the SMF of AN-TL information. In FIG. 8, the AMF reads the AN-TL information and forwards the same to the SMF, while in FIG. 9, the AMF forwards PDU Session Resource Setup Request Transfer including the AN-TL to the SMF.

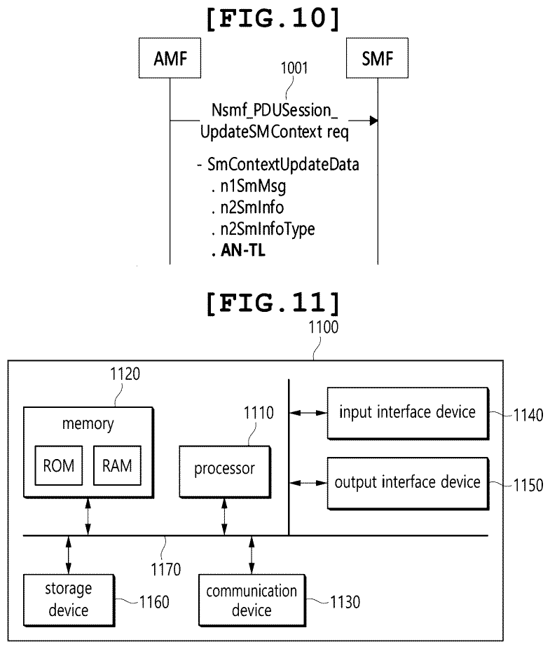

FIG. 10 shows an example in which an AMF makes a request to an SMF for a session modification service, according to an embodiment of the present disclosure. Specifically, FIG. 9 shows an example in which the AMF further makes a request to the SMF for Nsmf_PDUSession_UpdateSMContextservice.

Referring to FIG. 10, when the AMF requests the SMF to modify the session, Nsmf_PDUSession_UpdateSMContext service, which is a service based interface (SBI) service, is used. Herein, SmContextUpdateData may be included.

N1SmMsg may be an NAS message for a session modification request.

n2SmInfo, as a part of the NGAP message, is information transmitted by the RAN to the SMF, and n2SmInfoType may be type information of n2SmInfo. According to an embodiment, SmContextUpdateData may also include information on whether the RAN, which is the access network, provides a TSN talker/listener function.

According to an embodiment, SmContextUpdateData may include AN-TL information. Herein, the AN-TL may be represented in various forms indicating whether the RAN provides a TSN talker/listener function.

Referring to FIGS. 6 and 10, FIGS. 6 and 10 shows embodiments in which information on whether the RAN provides a TSN talker/listener function is included in SmContextCreateData or SmContextUpdateData, which is session establishment or modification request data. However, not limited to what is mentioned above, information indicating the AN-TL may be included outside of SmContextCreateData or SmContextUpdateData. In addition, by using a service other than a session establishment or modification request, the AMF may forward the information indicating the AN-TL to the RAN to report that the RAN is the AN-TL, and then may make the session establishment or modification request.

FIG. 11 shows a configuration of an apparatus according to various embodiments of the present disclosure. Referring to FIG. 2, the functional elements (e.g., the NRF, AMF, RAN, SMF, UE, DN, CUC, TN CNC, AN-TL, CN-TL, TSN bridge, and SFM/CUC) of the 5G network may include at least one processor 1110, a memory 1120, and a communication device 1130 that is connected to a network to perform communication. In addition, the functional elements of the 5G network may further include an input interface device 1140, an output interface device 1150, and a storage device 1160. Each of the elements included in the functional elements of the 5G network may be connected by a bus 1170 to communicate with each other.

However, with the processor 1110 in the center, each of the elements included in the functional elements of the 5G network may be connected via an individual interface or an individual bus, rather than the common bus 1170. For example, the processor 1110 may be connected via a dedicated interface to at least one of the following: the memory 1120, the communication device 1130, the input interface device 1140, the output interface device 1150, and the storage device 1160.

The processor 1110 may execute program commands stored in either the memory 1120 or the storage device 1160 or both. The processor 1110 may refer to a central processing unit (CPU), a graphics processing unit (GPU), or a dedicated processor on which methods according to embodiments of the present disclosure are performed. Each of the memory 1120 and the storage device 1160 may include either a volatile storage medium or a non-volatile storage medium or both. For example, the memory 1120 may include either read-only memory (ROM) or random-access memory (RAM) or both.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, multiple elements expressed in the description may be configured into a single element, or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method of giving notification of whether a radio access network (RAN) supports a time-sensitive networking (TSN) talker/listener in a wireless communication system, the method comprising:
notifying, by the RAN, either an access and mobility management function (AMF) or a session management function (SMF) by using an NGAP message.

2. The method of claim 1, wherein the NGAP message is an NGAP initial context setup message.

3. A method of giving notification of whether a radio access network (RAN) supports a time-sensitive networking (TSN) talker/listener in a wireless communication system, the method comprising:
notifying, by an access and mobility management function (AMF), a session management function (SMF) by using a service based interface (SBI).

4. The method of claim 3, wherein the SBI is either Nsmf_PDUSession_CreateSMContext or Nsmf_PDUSession_UpdateSMContext.

5. The method of claim 4, wherein the SBI includes information on whether the RAN supports the TSN talker/listener in either SmContextCreateData or SmContextUpdateData.

6. An operation method of a session management function (SMF) in a wireless communication system, the operation method comprising:
registering the SMF at a network repository function (NRF) by using an NFRegister message including information indicating that the SMF is co-located with a centralized user configuration (CUC).

7. The operation method of claim 6, wherein the NFRegister message includes, in NFProfile, the information indicating that the SMF is co-located with the CUC.

8. The operation method of claim 7, wherein SmfInfo included in the NFProfile includes the information indicating that the SMF is co-located with the CUC.
